(19) United States
(12) Patent Application Publication
(10) Pub. No.: US 2004/0131276 A1
(43) Pub. Date: Jul. 8, 2004

(54) Region-based image processor

(76) Inventor: John Hudson, Burlington (CA)

Correspondence Address: Joseph M. Sauer, Esq., Jones Day, North Point/901 Lakeside Avenue, Cleveland, OH, 44114, US

(21) Appl. No.: 10/739,652

(22) Filed: Dec. 18, 2003

Related U.S. Application Data
(60) Provisional application No. 60/436,059, filed on Dec. 23, 2002.

(51) Int. Cl. G06K 9/36; G06K 9/40

(52) U.S. Cl. 382/276; 382/254

(57) ABSTRACT

In accordance with the teachings described herein, systems and methods are provided for a region-based image processor. An image raster may be generated from one or more images to include a plurality of defined image regions. An image processing function may be applied to the image raster. A different configuration of the image processing function may be applied to each of the plurality of image regions.

### CROSS-REFERENCE TO RELATED APPLICATION

This application claims priority from and is related to the following prior application: “Region-Based Image Processor,” U.S. Provisional Application No. 60/436,059, filed Dec. 23, 2002. This prior application, including the entire written description and drawing figures, is hereby incorporated into the present application by reference.

### FIELD

The technology described in this patent document relates generally to the fields of digital signal processing, image processing, video and graphics. More particularly, the patent document describes a region-based image processor.

### BACKGROUND

Traditionally, applying an image processing block to an input image requires the entire raster to be processed in the same mode. FIGS. 1A and 1B illustrate two typical image processing techniques 1, 5. As illustrated in FIG. 1A, if the input image has one or more regions which would optimally require separate processing modes, a compromise typically occurs such that only one mode is applied to the entire raster with a fixed mode processing block 3. If the input image is the result of two or more multiplexed images and customized processing is desired for each image, then separate image processing blocks 7, 9 are typically applied before the multiplexing stage, as illustrated in FIG. 1B. The image processing method of FIG. 1B, however, requires multiple processing blocks 7, 9, typically compromising device bandwidth and/or increasing resources and processing overhead. Region-based processing helps to alleviate these and other shortcomings by applying different modes of processing to specific areas of the input image raster.

### SUMMARY

In accordance with the teachings described herein, systems and methods are provided for a region-based image processor. An image raster may be generated from one or more images to include a plurality of defined image regions. An image processing function may be applied to the image raster. A different configuration of the image processing function may be applied to each of the plurality of image regions.

### BRIEF DESCRIPTION OF THE DRAWINGS

FIGS. 1A and 1B illustrate two typical image processing techniques;

FIG. 2 is a block diagram of an example region-based image processor;

FIG. 2A is a block diagram of another example region-based image processor having multiple image inputs;

FIG. 3 is a block diagram illustrating an example image processing technique utilizing a region-based image processor;

FIG. 4 is a block diagram illustrating another example image processing technique utilizing a region-based image processor;

FIG. 5 illustrates an example image raster having two distinct regions;

FIG. 6 is a more-detailed block diagram of an example region-based image processor;

FIG. 7 is a block diagram illustrating one example configuration for a region-based image processor;

FIG. 8 illustrates an example of image scaling;

FIG. 9 shows an image mixing example for combining two images of ½ WXGA resolution in a picture-by-picture implementation to form a single WXGA image;

FIG. 10 illustrates an example of region-based deinterlacing;

FIG. 11 is a block diagram illustrating a preferred configuration for a region-based image processor; and

FIG. 12 illustrates an example of image scaling in the preferred configuration of FIG. 11.

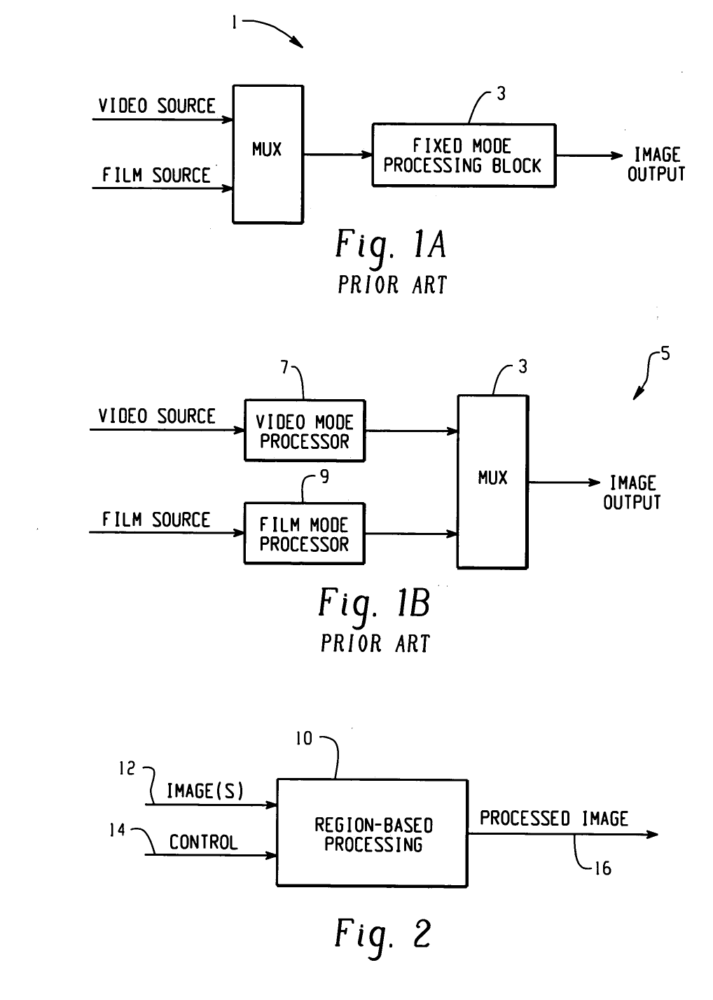

### DETAILED DESCRIPTION

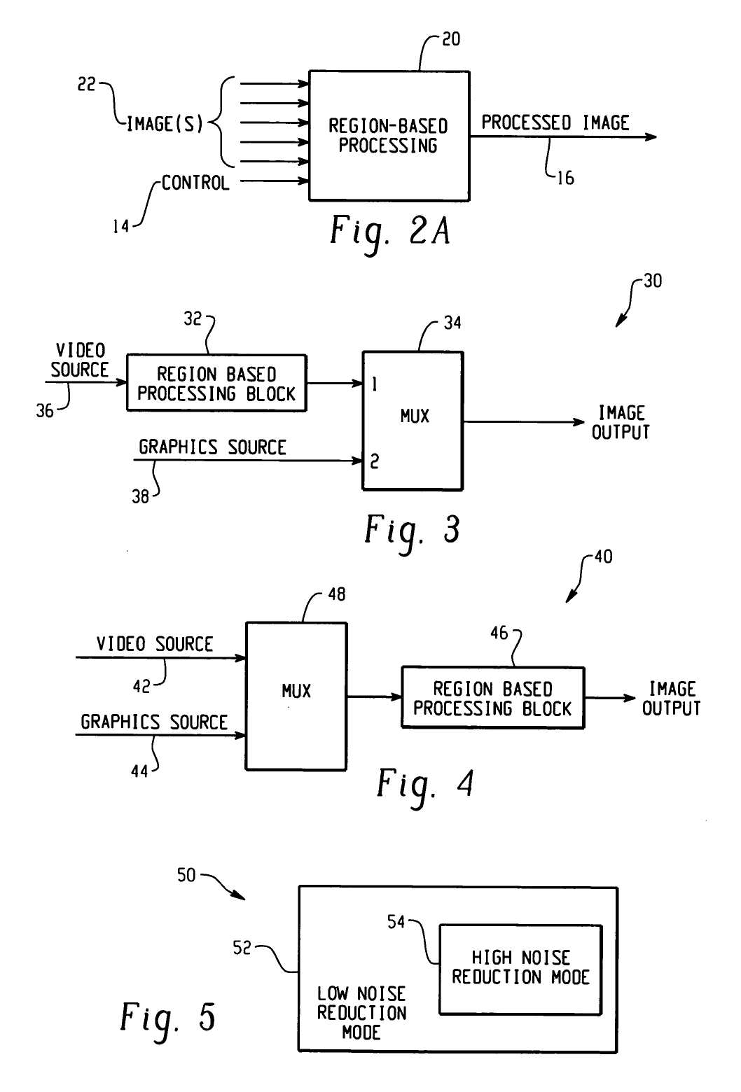

With reference now to the drawing figures, FIG. 2 is a block diagram of an example region-based image processor 10. The region-based image processor 10 receives one or more input image(s) 12 and a control signal 14 and generates a processed image output 16. The input image(s) 12 may have one or more regions that require processing. (See, e.g., FIG. 5). The region-based image processor 10 selectively applies processing modes to one or more regions within the image(s) 12. That is, different processing modes may be applied by the region-based image processor 10 to different regions within an image raster. The image regions and processing modes may be defined by control parameters included in the control signal 14. Alternatively, control parameters may be generated internally to the region-based image processor 10 based on analysis of the input image(s) 12.

The region-based technique illustrated in FIG. 2 preferably uses only a single core image processing block, thus optimizing processing while minimizing device resources, overhead and bandwidth. In addition, the region-based image processor 10 adds a level of input format flexibility, enabling the processing mode to be switched adaptively based on the type of input. Thus, if the type of images within the raster are changed, the processing can change accordingly.

FIG. 2A is a block diagram of another example region-based image processor 20 having multiple image inputs 22. In this example 20, the multiple input images 22 may be multiplexed within the region-based processor 20 to generate an image raster with distinct regions. Region-based processing may then be applied to the image raster. Alternatively, if image mixing (e.g., multiplexing) has occurred upstream, then the region-based processor 20 may also receive and process the single image input, as described with reference to FIG. 2.

It should be understood that region based image processing may also be used without two or more distinct video inputs. For example, a single video input image that has acquired noise during broadcast/transmission may be received and combined with a detailed graphic overlay. A region-based processing device may process the orignal image seperately from the overlay even though there is only a single image input raster. In addition, multiple regions may be defined within a single video or graphic image.

FIG. 3 is a block diagram 30 illustrating an example region-based image processing system having dedicated video and graphics inputs 36, 38. In this example 30, the region-based processing block 32 is located upstream from the video mixer (e.g., multiplexer) 34 and applied to a dedicated video input 36. The processed video is then multiplexed with a graphics source 38. This example 30 utilizes dedicated video and graphics inputs, as a video input into channel 2 of the mixer 34 would not go through the video processing block 34.

FIG. 4 is a block diagram 40 illustrating an example region-based image processing system having non-dedicated video and graphics inputs 42, 44. In this example, the region-based image processing block 46 is downstream from the video mixer 48 and applies video processing in the appropriate region of the multiplexed image.

FIG. 5 illustrates an example image raster 50 having two distinct regions 52, 54. As illustrated, the distinct regions 52, 54 of the image raster 50 may be processed in different modes (e.g., low noise reduction mode and high noise reduction mode) by a region-based image processor. As an example, a first region 52 may be a very clean (noise free) image from a quality source while a second region 54 may be from a noisy source. A region-based processor can thus apply minimal or no processing to the first region 52 while applying a greater degree of noise reduction to the second region 54.

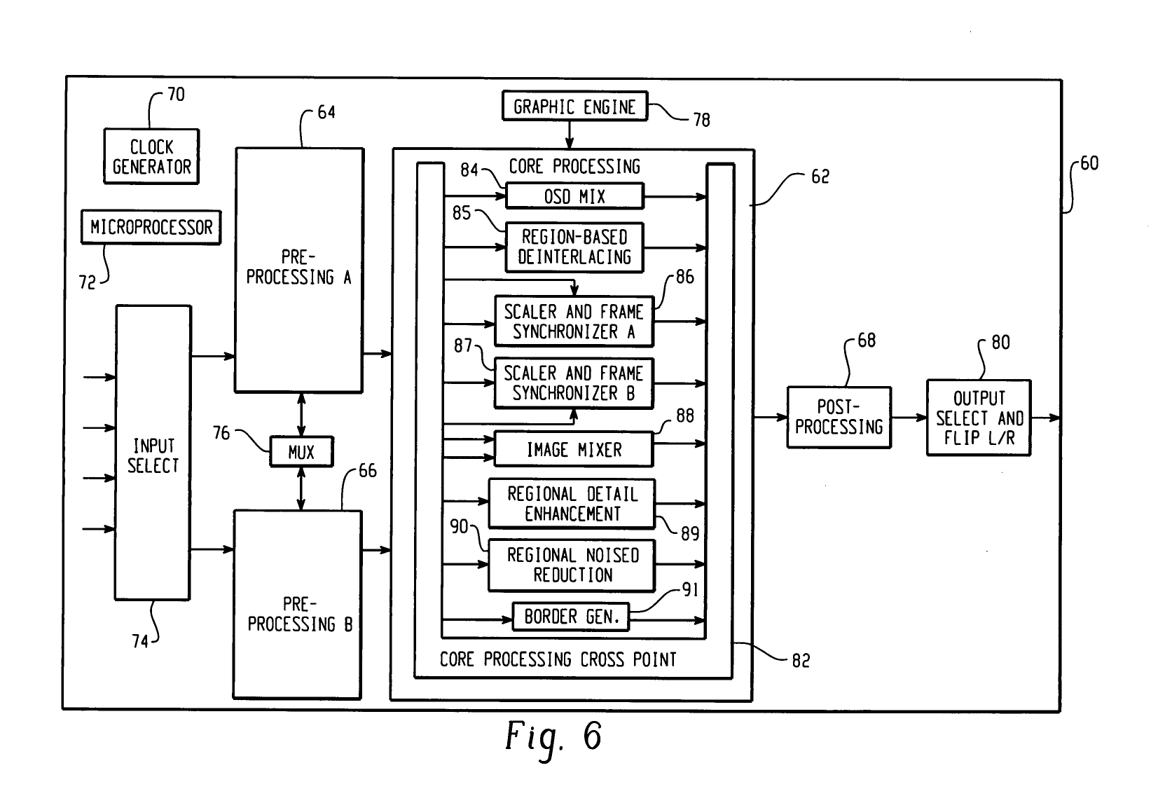

FIG. 6 is a more-detailed block diagram of an example region-based image processor 60. The region-based image processor 60 includes a core processor 62, two pre-processing blocks (A and B) 64, 66, and a post-processing block 68. Also included in the example region-based image processor 60 are a clock generator 70, a microprocessor 72, an input select block 74, a multiplexer 76, a graphic engine 78, and an output select block 80. The core processor 62 includes a cross point switch 82 and a plurality of core processing blocks 84-91. The example core processing blocks include an on screen display (OSD) mixer 84, a region-based deinterlacing block 85, a first scaler and frame synchronizer (A) 86, a second scaler and frame synchronizer (B) 87, an image mixer 88, a regional detail enhancement block 89, a regional noise reduction block 90, and a border generation block 91.

The input select block 74 may be included to select one or more simultaneous video input signals for processing from a plurality of different input video signals. In the illustrated example, two simultaneous video input signals may be selected and respectively input to the first and second pre-processing blocks 64, 66. The pre-processing blocks 64, 66 may be configurable to perform pre-processing functions, such as signal timing measurement, signal level measurement, input black level removal, sampling structure conversion (e.g., 4:2:2 to 4:4:4), input color space conversion, input picture level control, and/or other functions. The multiplexer 76 may be operable in a dual pixel port mode to multiplex the odd and even bits into a single stream for processing by subsequent processing blocks.

The graphic engine 78 may be operable to process one or more graphic images. For example, the graphic engine 78 may be a micro-coded processor operable to execute user programmable instructions to manipulate bit-mapped data (e.g., sprites) in memory to create a graphic display. The graphic display created by the graphic engine 78 may be mixed with the video image(s) by the core processor 62.

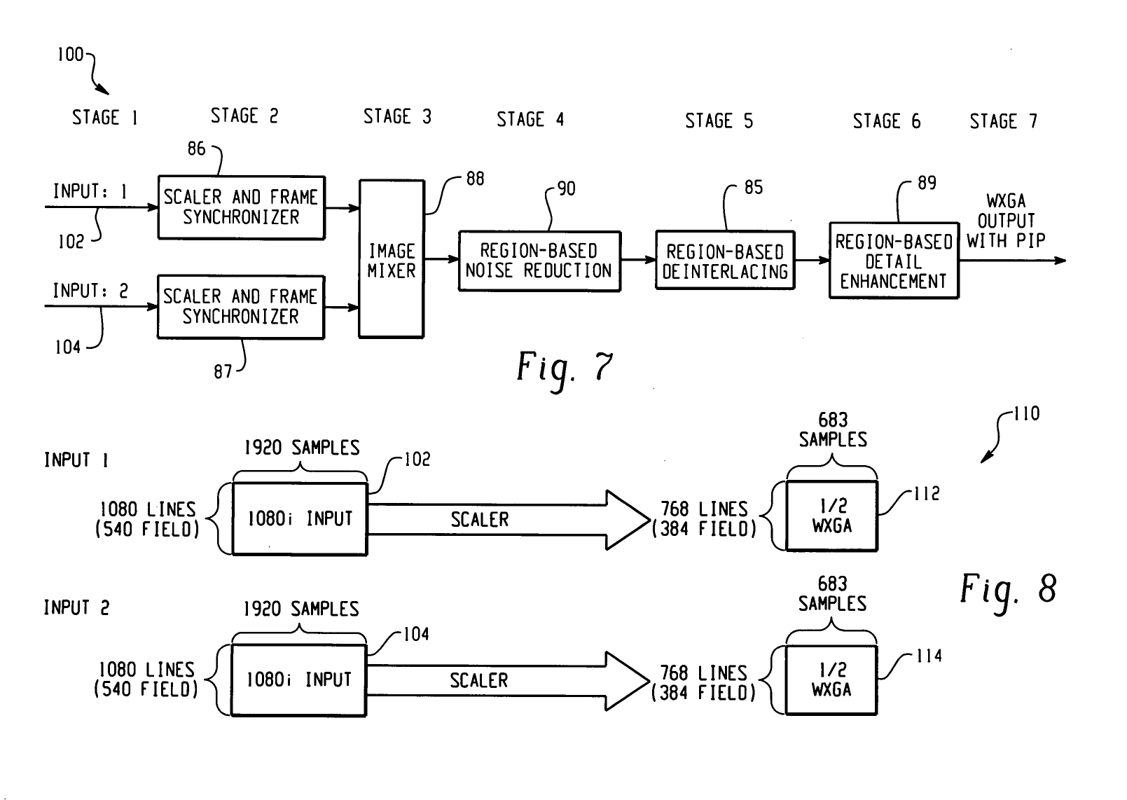

The core processor 62 may be configured by the microprocessor 72 to apply different combinations of the core processing blocks 84-91. The processing block configuration within the core processor 62 is controlled by the cross point switch 82, which may be programmed to enable or disable various core processing blocks 84-91 and to change their sequential order. One example configuration for the core processor 62 is described below with reference to FIG. 7.

Within the core processor 62, the OSD mixer 84 may be operable to combine graphics layers created by the graphic engine 78 with input video images to generate a composite image. The OSD mixer 84 may also combine a hardware cursor and/or other image data into the composite image. The OSD mixer 84 may provide pixel-by-pixel mixing of the video image(s), graphics layer(s), cursor images and/or other image data. In addition, the OSD mixer 84 may be configured to switch the ordering of the video layer(s) and the graphic layer(s) on a pixel-by-pixel basis so that different elements of the graphics layer can be prominent.

The region-based deinterlacing block 85 may be operable to generate a progressively-scanned version of an interlaced input image. A further description of an example region-based deinterlacing block 85 is provided below with reference to FIGS. 7 and 11.

The scaler and frame synchronizers 86, 87 may be operable to apply vertical and horizontal interpolation filters and to synchronize the timing of the input video signals. Depending on the configuration, the input video signals could be synchronized to each other or to the output video frame rate. A further description of example scaler and frame synchronizers 86, 87 is provided below with reference to FIGS. 7 and 11.

The image mixer 88 may be operable to superimpose or blend images from the video inputs. Input images may, for example, be superimposed for picture-in-picture (PIP) applications, alpha blended for picture-on-picture (POP) applications, placed side-by-side for picture-by-picture (PBP) applications, or otherwise combined. Picture positioning information used by the image mixer 88 may be provided by the scaler and frame synchronizers 86, 87. A further description of an example image mixer 88 is provided below with reference to FIGS. 7 and 11.

The regional detail enhancement block 89 may be operable to process input data to provide an adaptive detail enhancement function. The regional detail enhancement block 89 may apply different detail adjustment values in different user-defined areas or regions of an output image. For each image region, threshold values may be selected to indicate the level of refinement or detail detection to be applied. For example, lower threshold values may correspond to smaller levels of detail that can be detected. The amount of gain or enhancement to be applied may also be defined for each region. A further description of an example regional detail enhancement block 89 is provided below with reference to FIGS. 7 and 11.

The regional noise reduction block 90 may apply different noise adjustment values in different user-defined areas or regions of an output image. For example, each image region may have a different noise reduction level that can be adjusted from no noise reduction to full noise reduction. A further description of an example regional noise reduction block 90 is provided below with reference to FIGS. 7 and 11.

The border generation block 91 may be operable to add a border around the output image. For example, the border generation block 91 may add a border around an image having a user-defined size, shape, color and/or other characteristics.

With reference now to the output stage 68, 80 of the region-based image processor 60, the post-processing block 68 may be configurable to perform post-processing functions, such as regional picture level control, vertical keystone and angle correction, color balance control, output color space conversion, sampling structure conversion (e.g., 4:4:4 to 4:2:2), linear or non-linear video data mapping (e.g., compression, expansion, gamma correction), black level control, maximum output clipping, dithering, and/or other functions. The output select block 80 may be operable to perform output port configuration functions, such as routing the video output to one or more selected output ports, selecting the output resolution, selecting whether output video active pixels are flipped left-to-right or normally scanned, selecting the output video format and/or other functions.

FIG. 7 is a block diagram illustrating one example configuration 100 for a region-based image processor. The illustrated configuration 100 may, for example, be implemented by programming the reconfigurable core processor 62 in the example region-based image processor 60 of FIG. 6. The illustrated region-based processing configuration 100 includes seven (7) stages, beginning with a video input stage (stage 1) and ending with a video output stage (stage 7). It should be understood, however, that the illustrated configuration 100 represents only one example mode of operation (i.e., configuration) for a region-based image processing device, such as the example region-based processor 60 of FIG. 6.

Stage 1

Stage 1 of FIG. 7 illustrates an example video input stage having two high definition video inputs (Input 1 and Input 2) 102, 104. The video inputs 102, 104 may, for example, be respectively output from the pre-processing blocks 64, 66 of FIG. 6. For the purposes of this example 100 the video input parameters are as follows: the first video input 102 is a 1080i30 video input originally sourced from film having a 3:2 field cadence, the second video input 104 is a 1080i30 video input originally captured from a high definition video camera, and both video inputs 102, 104 have 60 Hz field rates. It should be understood, however, that other video inputs may be used. Standard definition video, progressive video, graphics inputs and arbitrary display modes may also be used in a preferred implementation.

Stage 2

Stage 2 of FIG. 7 illustrates an example scaling and frame synchronization configuration applied to each of the two video inputs 102, 104 in order to individually scale the video inputs to a pre-selected video output size. In this manner, bandwidth may be conserved in cases where the output raster is smaller than the sum of the input image sizes because downstream processing is performed only on images that will be viewed.

An example of image scaling 110 is illustrated in FIG. 8 for a picture-by-picture implementation for WXGA (1366 samples by 768 lines), assuming the example video input parameters described above for stage 1. In the illustrated example 110, the two video inputs 102, 104 are each scaled to one half of WXGA resolution. That is, the first video input 102 is downscaled horizontally by a factor of 2.811 and vertically by a factor of 1.406, and the second video input 104 is downscaled horizontally by a factor of 2.811 and vertically by a factor of 1,406. In this manner, bandwidth may be conserved by processing two images of ½ WXGA resolution rather than two images of full-bandwidth high definition video.

A picture-in-picture mode can also be implemented by adjusting the scaling factors in the input scalers 86, 87 and the picture positioning controls in the image mixing blocks (discussed in Stage 3). Effects can be generated by dynamically changing the scaling, positioning and alpha blending controls. The image is interlaced in this particular example 110, but progressive scan and graphics inputs could also be utilized.

In addition, frame synchronizers may be used to align the timing of the input images such that all processing downstream can take place with a single set of timing parameters.

Stage 3

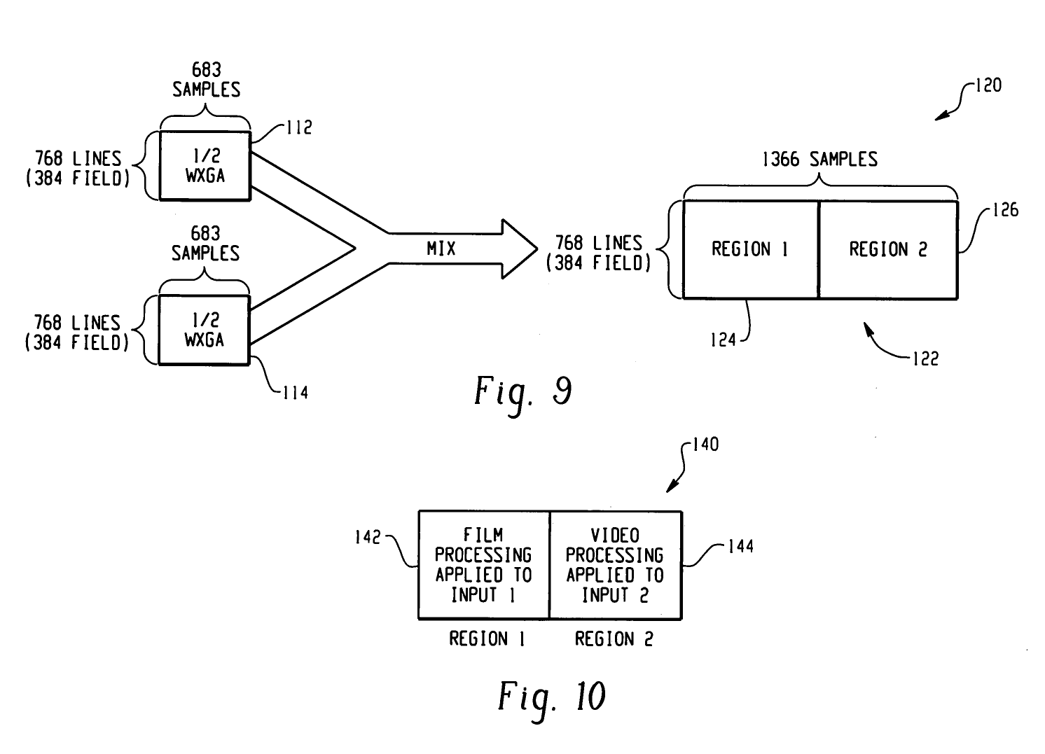

Stage 3 of FIG. 7 illustrates an example image mixer configuration. The image mixer 88 combines the two scaled images to form a single raster image having two distinct regions. An image mixing example is illustrated in FIG. 9 for combining two images of ½ WXGA resolution 112, 114 in a picture-by-picture implementation to form a single WXGA image 112. The mixed (e.g., multiplexed) WXGA image 122 includes two distinct regions 124, 126 which correspond with the first video input 102 and the second video input 104, respectively. Assuming the example video parameters described above, the first region 124 contains a 3:2 field cadence while the second region 126 contains a standard video source field cadence. In this example 120, the image is interlaced, but other examples could include progressive scan and graphics inputs.

Stage 4

Stage 4 of FIG. 7 illustrates an example region-based noise reduction configuration. The region-based noise reduction block 90 is operable to apply different noise reduction processing modes to different regions of the image. The input to the region-based noise reduction block 90 may include region-segmented interlaced, progressive or graphics inputs, or combinations thereof. The different regions of a received image may, for example, be defined by control information generated at the scaling and mixing stages 86-88, by other external means (e.g., user input), or may be detected and generated internally within the region-based block 90.

For example, if the region-based noise reduction block 90 receives a video input with a first region from a clean source and a second region that contains noise, then different degrees of noise reduction may be applied as needed to each region. For instance, the region-based noise reduction block 90 may apply a minimal (e.g., completely off) noise reduction mode to a clean region(s) and a higher noise reduction mode to a noisy region(s).

Stage 5

Stage 5 of FIG. 7 illustrates an example region-based deinterlacing configuration. The region-based deinterlacing block 85 is operable to apply de-interlacing techniques that are optimized for the specific regions of a received image raster. The output image from the region-based deinterlacing block 85 is fully progressive (e.g., 768 lines for WXGA). In this manner, an optimal type of de-interlacing may be applied to each region of the image raster. Similar to the region-based noise reduction block 90, the input to the region-based deinterlacing block 85 may include region-segmented interlaced, progressive or graphics inputs, or combinations thereof, and the different regions of a received image may, for example, be defined by control information generated at the scaling and mixing stages 86-88, by other external means (e.g., user input), or may be detected and generated internally within the region-based block 85.

An example of region-based deinterlacing is illustrated in FIG. 10. In the example of FIG. 10, a film processing mode (e.g., 3:2 inverse pulldown) is applied to a first region 142 of the image raster 140 and a video processing mode (e.g., perfoming motion adaptive algorithms) is applied to a second region 144 of the image raster 140.

Stage 6

Stage 6 of FIG. 7 illustrates an example region-based detail enhancement configuration. Similar to the region-based processing blocks in stages 4 and 5, the region-based detail enhancement block 89 is operable to apply detail enhancement techniques that are optimized for the specific regions of a received image raster. The input to the region-based detail enhancement block 89 may include region segmented interlaced, progressive or graphics inputs, or combinations thereof, and the different regions of the input image may be defined by control information, by other external means, or may be detected and generated internally within the region-based block 89. For example, the region-based detail enhancement block 89 may generate a uniformly-detailed output image by applying different degrees of detail enhancment, as needed, to each region of an image raster.

Stage 7

Stage 7 of FIG. 7 illustrates an example video output stage having a WXGA output with picture-in-picture (PIP). The video output may, for example, be output for further processing, sent to a display/storage device or distributed. For example, the video output from stage 7 may be input to the post-processing block 68 of FIG. 6.

FIG. 11 is a block diagram illustrating a preferred configuration 200 for a region-based image processor. The illustrated configuration 200 may, for example, be implemented by programming the reconfigurable core processor 62 in the example region-based image processor 60 of FIG. 6. This preferred region-based image processor configuration 200 is similar to the example configuration of FIG. 7, except that the image is scaled 212 (stage 7 of FIG. 11) after the region-based processing blocks 209-211 instead of before mixing (stage 2 of FIG. 7). At stage 2 of FIG. 11, the input images 202, 204 are synchronzed in synchronization blocks 206, 207 to ensure that the images 202, 204 are horizontally, vertically and time coincident with each other prior to combination in the image mixer 208 (stage 3). Image mixing and region-based image processing functions are then performed at stages 3-6, similar to FIG. 7. At stage 7 of FIG. 11, the resultant noise reduced, de-interlaced and detail-enhanced image is scaled both horizontally and vertically in the scaler and frame synchronizer block 212 to fit the required output raster.

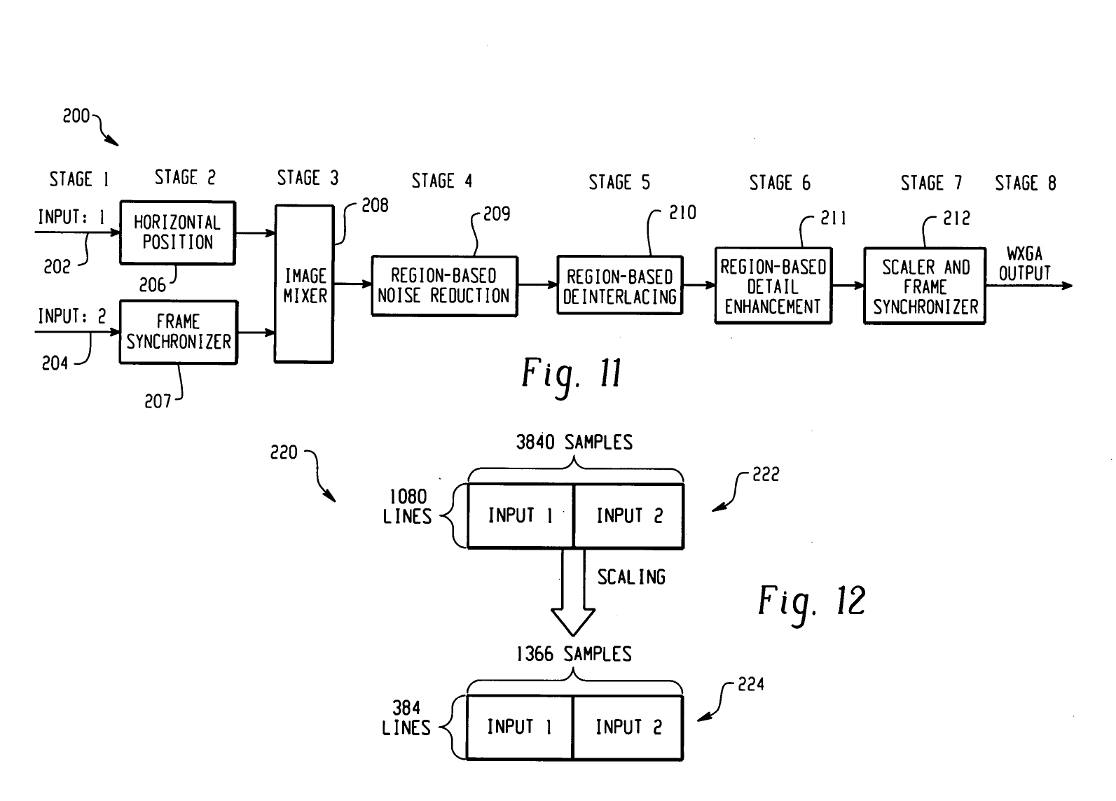

An example 220 of the image scaling function 212 is illustrated at FIG. 12. In the example of FIG. 12, the input image 222 aspect ratio is maintained by applying the same horizontal and vetical scaling ratios to produce an image 224 with 1366 samples by 384 lines. Other aspect ratios may be achieved by applying different horizontal and vertical scaling ratios.

This written description uses examples to disclose the invention, including the best mode, and also to enable a person skilled in the art to make and use the invention. The patentable scope of the invention may include other examples that occur to those skilled in the art.

It is claimed:

1. A region-based image processor, comprising:
an image mixer operable to combine a plurality of images to generate an image raster;
the image raster including a plurality of defined image regions, each image region corresponding to one of the plurality of images;
an image processing block operable to apply an image processing function to the image raster; and
the image processing block being further operable to apply a different configuration of the image processing function to each of the plurality of image regions.

2. The region-based image processor of claim 1, wherein the plurality of images includes one or more video image.

3. The region-based image processor of claim 1, wherein the plurality of images includes one or more graphical image.

4. The region-based image processor of claim 1, wherein the plurality of images includes a combination of video and graphical images.

5. The region-based image processor of claim 1, wherein the image processing function is a region-based noise reduction function, the region-based noise reduction function being configured separately for each image region.

6. The region-based image processor of claim 5, wherein the region-based noise reduction function is configured by a user to select a level of noise reduction for each of the image regions.

7. The region-based image processor of claim 1, wherein the image processing function is a region-based deinterlacing function, the region-based deinterlacing function being configured separately for each image region.

8. The region-based image processor of claim 1, wherein the image processing function is a region-based detail enhancement function, the region-based detail enhancement function being configured separately for each image region.

9. The region-based image processor of claim 8, wherein the region-based detail enhancement function is configured by a user to select a level of detail enhancement for each of the image regions.

10. The region-based image processor of claim 1, further comprising:
one or more additional image processing blocks operable to apply additional image processing functions to the image raster;
the one or more additional image processing blocks being further operable to apply a different configuration of the additional image processing functions to each of the plurality of image regions.

11. The region-based image processor of claim 10, wherein the image processing block and the additional image processing blocks include a region-based noise reduction block, a region-based deinterlacing block and a region-based detail enhancement block.

12. The region-based image processor of claim 10, wherein the image processing block and the one or more additional image processing blocks are implemented using a reconfigurable core processor.

13. The region-based image processor of claim 1, further comprising:
a plurality of frame synchronizers operable to synchronize the timing of the plurality of images.

14. The region-based image processor of claim 13, wherein the plurality of frame synchronizers synchronize the plurality of images with each other.

15. The region-based image processor of claim 13, wherein the plurality of frame synchronizers synchronize the plurality of images with an output video frame rate.

16. The region-based image processor of claim 1, further comprising:
a plurality of image scalers operable to individually scale the plurality of images to a preselected video size.

17. The region-based image processor of claim 16, wherein the plurality of image scalers include horizontal and vertical interpolation filters.

18. The region-based image processor of claim 1, further comprising:
an image scaler operable to scale the image raster to a pre-selected video size.

19. The region-based image processor of claim 18, wherein the image scaler includes horizontal and vertical interpolation filters.

20. The region-based image processor of claim 1, wherein the image mixer combines the plurality of images to generate a picture-in-picture (PIP) image raster.

21. The region-based image processor of claim 1, wherein the image mixer combines the plurality of images to generate a picture-on-picture (POP) image raster.

22. The region-based image processor of claim 1, wherein the image mixer combines the plurality of images to generate a picture-by-picture (PBP) image raster.

23. A region-based image processor, comprising:
means for synchronizing a plurality of image inputs to generate a plurality of synchronized image inputs;
means for combining a plurality of synchronized image inputs to generate an image raster that includes a plurality of defined image regions, each image region in the image raster corresponding to one of the plurality of synchronized image inputs;
a region-based noise reduction block operable to apply a different noise reduction mode to each of the image regions in the image raster;
a region-based deinterlacing block operable to apply a different deinterlacing technique to each of the image regions in the image raster;
a region-based detail enhancement block operable to apply a different detail enhancement mode to each of the image regions in the image raster; and
means for scaling the image raster to a pre-selected video size to generate an image output.

24. A method for processing a plurality of images, comprising:
receiving an image;
generating an image raster from the image;
identifying a first image region and a second image region in the image raster;
processing the first image region using a first configuration of an image processing function; and
processing the second image region using a second configuration of the image processing function.

25. The method of claim 24, further comprising:
receiving an additional image; and
combining the image and the additional image to generate the image raster.

26. The method of claim 25, wherein the first image region corresponds to the image and the second image region corresponds to the additional image.
